(19) United States
(12) Patent Application Publication
(10) Pub. No.: US 2010/0302047 A1
(43) Pub. Date: Dec. 2, 2010

(54) INTEGRATED WATER DETECTOR

(75) Inventor: Jonathan R. Wood, Sudbury, MA (US)

Correspondence Address: EDWARDS ANGELL PALMER & DODGE LLP, P.O. BOX 55874, BOSTON, MA, 02205, US

(73) Assignee: Altor Limited LC, Sudbury, MA (US)

(21) Appl. No.: 12/795,337

(22) Filed: Jun. 7, 2010

Related U.S. Application Data
(63) Continuation-in-part of application No. 12/008,525, filed on Jan. 11, 2008, now Pat. No. 7,753,071.
(60) Provisional application No. 60/884,566, filed on Jan. 11, 2007.

(51) Int. Cl. G08B 21/00

(52) U.S. Cl. 340/605

(57) ABSTRACT

A leak detector pad comprising a circuit board having a bottom surface and a top surface, spaced first and second electrically conductive traces located on the bottom surface, and an electronic circuit mounted on the top surface. The circuit includes a first segment adapted to create an alternating current (AC) voltage waveform, a second segment adapted to apply the AC voltage waveform between the traces on the bottom surface of the circuit board, a third segment adapted to create a measure of a capacitance between the traces based upon an AC current flowing between the traces as a result of the AC voltage waveform, and a fourth segment adapted to create a direct current (DC) voltage alarm signal if the measure of capacitance provided by the third segment indicates the presence of fluid.

### CROSS-REFERENCE TO RELATED APPLICATION

This application claims priority to U.S. Provisional Patent Application No. 60/884,566 filed Jan. 11, 2007 and also claims priority as a continuation-in-part to U.S. patent application Ser. No. 12/008,525 filed on Jan. 11, 2008, now issued as U.S. patent No. on June, 2010, each of which is incorporated herein by reference.

### TECHNICAL FIELD OF THE DISCLOSURE

The present disclosure generally relates to a water sensor and, more particularly, to a water detector integrated into another device. Even more particularly, the present disclosure relates to an integrated water detector for marine applications and other harsh conditions that can preferably work on low water levels such as an eighth of an inch or less.

### BACKGROUND OF THE DISCLOSURE

Household flooding costs homeowners and insurance companies millions of dollars in damages every year in the United States alone. Bursting pipes or leaking or malfunctioning appliances, for instance, can cause such household flooding. The resultant flooding often causes damage to the surrounding environment as well as to the appliance itself. For example, flooding of laundry rooms is such a common occurrence that many housing codes now require washing machines to be positioned within catch basins. Thus, when the inevitable overflow occurs, it is hoped that the water will be contained within the catch basins and that the water will not flow into other regions of the laundry rooms.

However, unless the manually operated shut-off valves, which are typically positioned at the wall behind most washing machines, are closed, water can surge unrestricted through a burst supply hose or can spill from the tank of the malfunctioning washing machine. It is estimated that the unrestricted flow through the hoses or from the tanks can be on the order of 3 gallons per minute or 180 gallons an hour. Clearly, in an unmonitored situation, the flow of water will rapidly exceed the storage capacity of a catch basin and also can exceed the capacity of a drain positioned within the catch basin.

Toilets can be a source of flooding as well. Generally, toilets include both a float valve and a seal that stops the flow of water into the toilet. If a drain line of the toilet becomes plugged, or if the float valve or seal malfunctions, water can spill from within the toilet bowl or refill tank onto the floor. In addition, the water supply line to the toilet can become loosened or can fail. In such instances, water will be surging onto the bathroom floor until the manually operated valve, which is typically located behind the toilet, is shut off. Thus, large amounts of water can flood a bathroom if the condition remains unmonitored.

Water heaters can also be a source of flooding. If a tank of the water heater springs a leak or if a water line connected to the water heater breaks, water will surge into the dwelling until the supply valve to the water heater is shut off. With water heaters, however, it is also desirable to shut off the flow of electricity and heating fuel, such as oil or gas, to the water heater.

Many prior art appliance leak detector and shut-off systems include a water sensor, or leak detector pad, a controller, and a water supply valve. The leak detector pad is placed on the floor near an appliance to be monitored. Upon contacting water during flooding, the detector pad sends a signal to the control, which in turn causes the water supply valve to close to prevent further flooding.

Bilge pumps and automatic sump pumps have typically employed mechanical float devices for detecting the presence of water to be pumped. Such mechanical devices may become inoperative as a result of any of a number of impediments such as biological growth, dust, grime, corrosion, ice, flotsam, and the like. Such mechanical devices are typically also not capable of detecting water to shallow depths, e.g., less than one eighth of an inch.

What is still desired is a new and improved leak detector. Preferably the leak detector will be compact, ruggedized, waterproof, include no moving parts, be protected from dirt and corrosion, and be reusable after a flood. In addition, the leak detector pad will preferably be able to transmit an alarm signal a relatively long distance, such as 150 feet.

### SUMMARY OF THE DISCLOSURE

The present disclosure provides a new and improved leak detector pad. According to one exemplary embodiment, the pad includes a circuit board having a bottom surface and a top surface, spaced first and second electrically conductive traces located on the bottom surface, and an electronic circuit mounted on the top surface. The circuit includes a first segment adapted to create an alternating current (AC) voltage waveform, a second segment adapted to apply the AC voltage waveform between the traces on the bottom surface of the circuit board, a third segment adapted to create a measure of a capacitance between the traces based upon an AC current flowing between the traces as a result of the AC voltage waveform, and a fourth segment adapted to create a direct current (DC) voltage alarm signal if the measure of capacitance provided by the third segment indicates the presence of fluid.

According to one aspect, the leak detector pad further includes a watertight encapsulation layer covering the top and bottom surfaces of the circuit board and the electronic circuit and the traces. According to an additional aspect, the pad also includes a relatively thicker shock-absorbing, watertight over-mold layer covering the encapsulation layer on the top surface of the circuit board and the electronic circuit, side edges of the circuit board, and the encapsulation layer on edge portions of the bottom surface of the circuit board.

Among other aspects and advantages, the new and improved leak detector pad of the present disclosure is compact, ruggedized, waterproof, includes no moving parts, is protected from dirt and corrosion, and can be reused after a flood. In addition, the DC voltage alarm signal produced by the leak detector pad can be transmitted a relatively long distance.

In another embodiment, the subject technology is useful with bilge pumps in boats, and for use with sump pumps in buildings because the non-mechanical water detection can be integrated into a water pump assembly. Further, the integrated water detector is relatively immune to impediments such as algae and marine or freshwater biological growth, as well as the accumulation of dust and grime, and corrosion. The subject technology is also capable of operating in water that is partly frozen, operating in the presence of flotsam, jetsam, and other particulate matter within the water to be pumped, and detecting water to shallow depths, e.g., one eighth of an inch or less.

Additional aspects and advantages of the present disclosure will become readily apparent to those skilled in this art from the following detailed description, wherein only an exemplary embodiment of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

Reference is made to the attached drawings, wherein elements having the same reference character designations represent like elements throughout.

FIG. 1 is a perspective view of two exemplary embodiments of water heater leak detector shut-off systems including leak detector pads constructed in accordance with the present disclosure.

FIG. 2 is an enlarged top plan view of the leak detector pad of FIG. 1.

FIG. 3 is a further enlarged top plan view of the leak detector pad of FIG. 1.

FIG. 4 is an enlarged side elevation view of the leak detector pad of FIG. 1.

FIG. 5 is a further enlarged side elevation view of the leak detector pad of FIG. 1.

FIG. 6 is an even further enlarged side elevation view of a portion of the leak detector pad of FIG. 1 contained within circle 6 of FIG. 5.

FIG. 7 is an enlarged bottom plan view of the leak detector pad of FIG. 1.

FIG. 8 is a further enlarged bottom plan view of the leak detector pad of FIG. 1.

FIG. 9 is a plan view of a bottom surface of a circuit board of the leak detector pad of FIG. 1, wherein exemplary embodiments of two traces according to the present disclosure are shown.

FIG. 10 is a plan view of a top surface of the circuit board of the leak detector pad of FIG. 1, wherein an exemplary embodiments of a layout of an electronic circuit according to the present disclosure is shown.

FIG. 11 is a block diagram of the electronic circuit of the leak detector pad of FIG. 1.

FIG. 12 is an exemplary embodiment of an electrical schematic of the electronic circuit of the leak detector pad of FIG. 1.

FIGS. 13A, 13B, and 13C are an enlarged view of the schematic of FIG. 12.

FIG. 14 is a plan view of a bottom surface of a circuit board of another leak detector pad having exemplary embodiments of two sets of traces according to the present disclosure.

FIG. 15 is a plan view of a bottom surface of a circuit board of another leak detector pad having exemplary embodiments of two elongated sets of traces according to the present disclosure.

FIG. 16 is a plan view of a bottom surface of a circuit board of another leak detector pad having exemplary embodiments of two arcuate sets of traces according to the present disclosure.

FIG. 17 is a plan view of a bottom surface of a circuit board of another leak detector pad having exemplary embodiments of two circular sets of traces according to the present disclosure.

FIG. 18 is a plan view of a bottom surface of a circuit board of another leak detector pad having exemplary embodiments of two rectangular sets of traces according to the present disclosure.

FIG. 19 is a perspective view of an integrated arrangement wherein a water pump is mounted on top of a printed circuit board having a leak detector pad.

FIG. 20 is a side view of the integrated arrangement of FIG. 19.

### DETAILED DESCRIPTION OF EXEMPLARY EMBODIMENTS

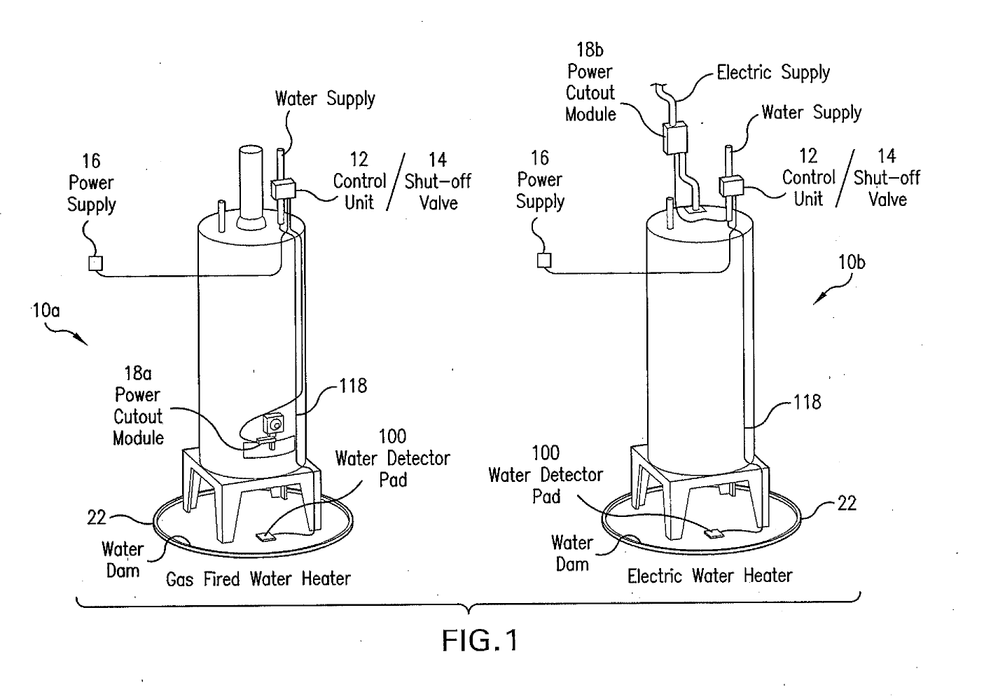

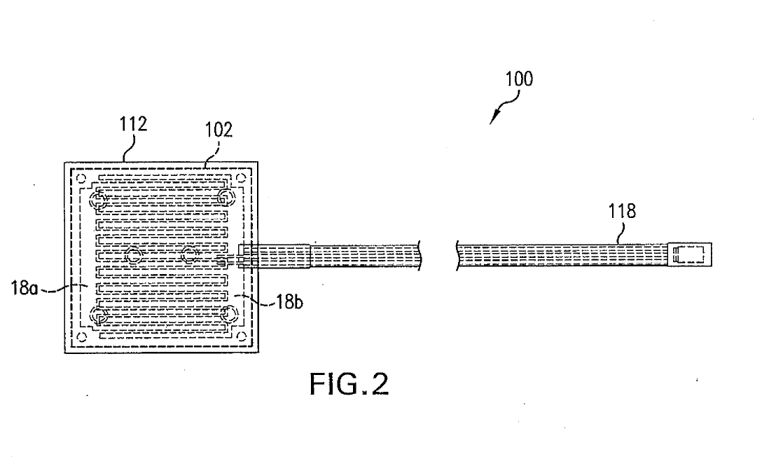

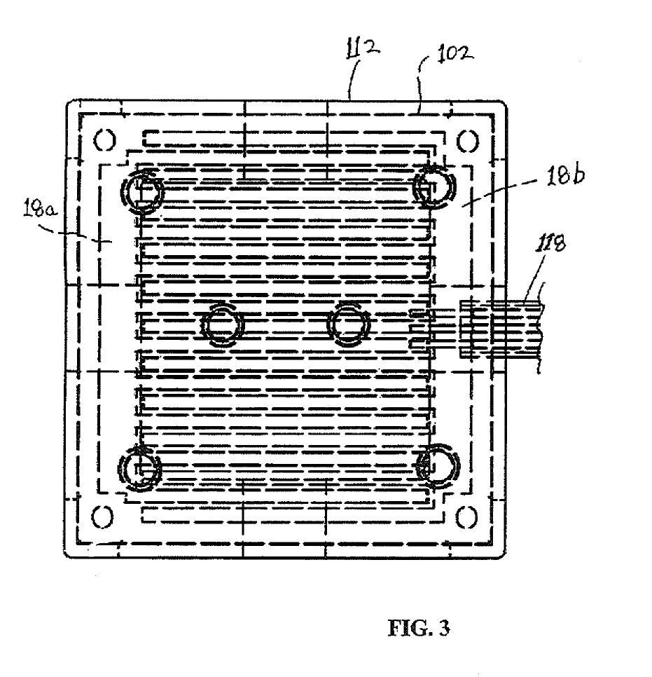

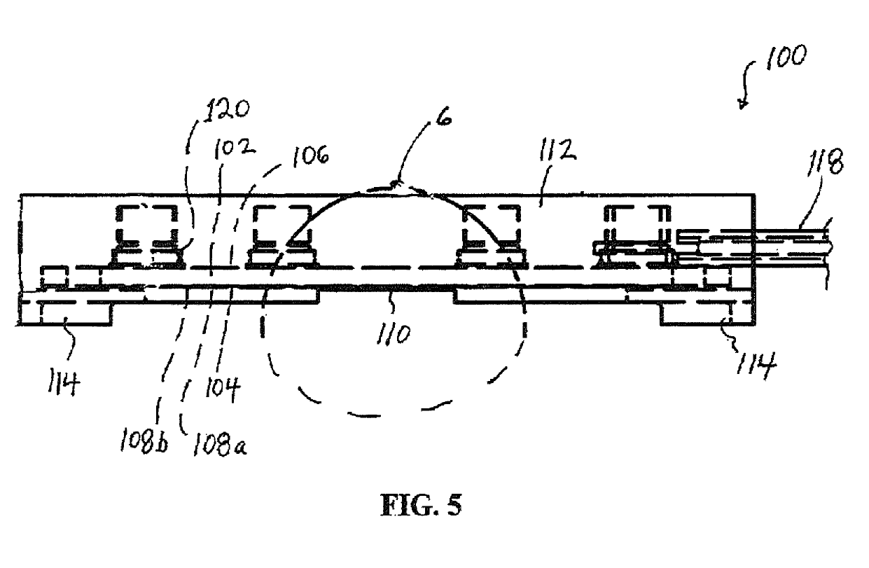

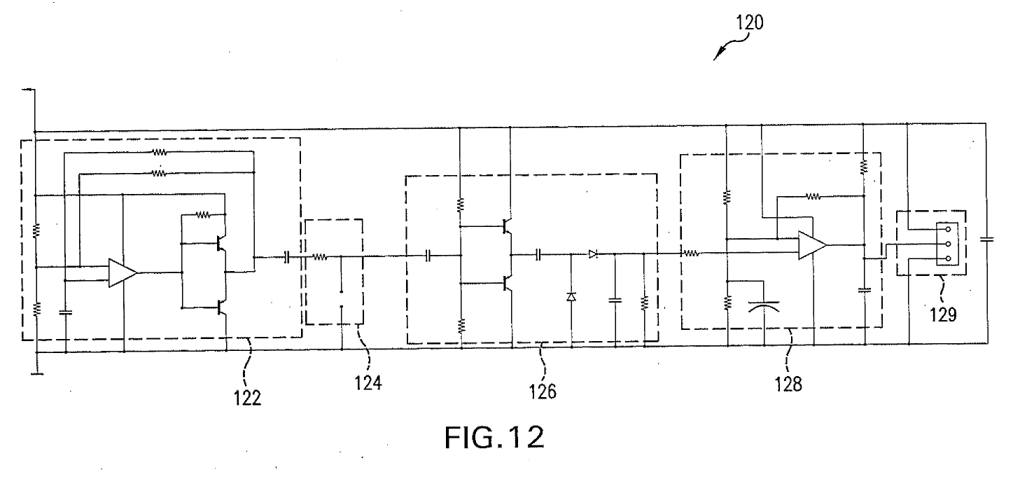

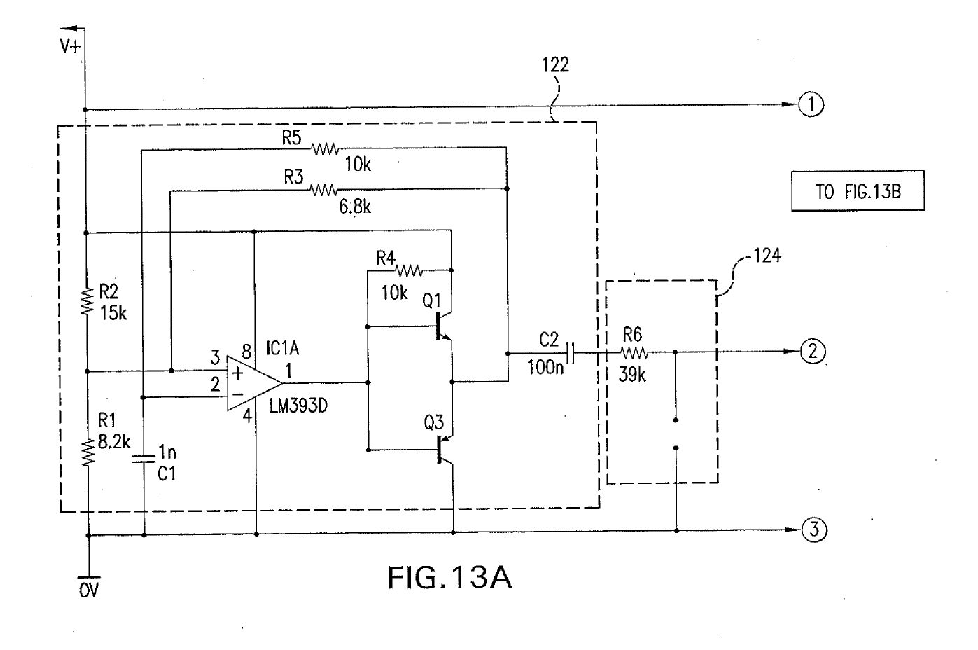

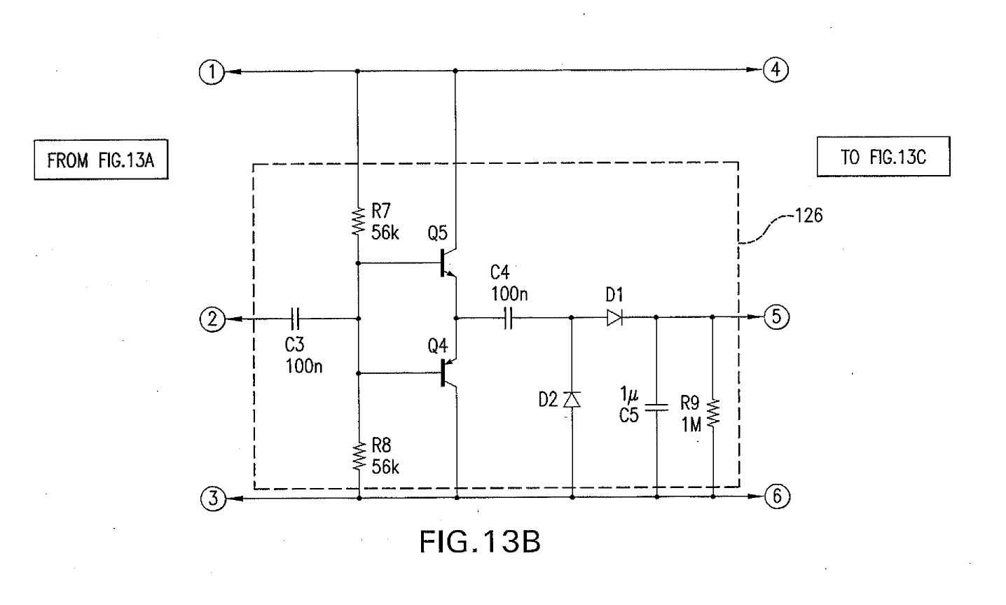

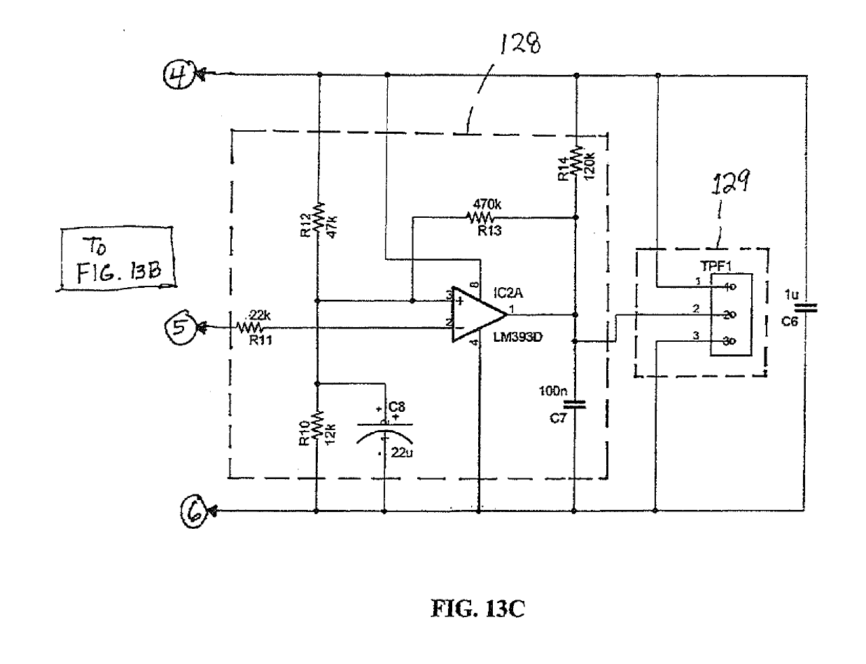

Referring to FIG. 1, there are shown two exemplary embodiments of water heater leak detector shut-off systems 10a, 10b including new and improved leak detector pads 100 constructed in accordance with the present disclosure. Among other benefits, the new and improved leak detector pad 100 of the present disclosure is compact, ruggedized, waterproof, includes no moving parts, is protected from dirt and corrosion, and can be reused after a flood. In addition, the leak detector pad 100 can transmit a signal a relatively long distance, such as 150 feet. FIGS. 2-13 provide further detailed views of the detector pad 100, but first the shut-off systems 10a, 10b are discussed to provide background information for the detector pad.

In FIG. 1 there is shown a gas water heater and an electric water heater. In both cases, the shut-off systems 10a, 10b include a control unit 12, a water supply shut-off valve 14, and a power supply 16 in addition to the leak detector pads 100. The power supply 16 is adapted to receive an alternating current (AC) voltage and convert the AC voltage to a direct current (DC) voltage for the shut-off system. For the gas water heater, the shut-off system 10a also includes a power cutout module 18a for a natural gas burner of the heater (for oil heaters the power cutout module is connected to an oil burner), while for the electric water heater the shut-off system 10b includes a power cutout module 18b for an electricity supply line connected to the heater. The shut-off systems also include water dams 22, which surround the water detector pads 100 to collect water leaking from the heaters.

During a flood that is a result of a leak from the water heaters, water collects around the water detector pads 100 and the pads send alarm signals to the control units 12, which in turn activate the shut-off valves 14 and the power cutout modules 18a, 18b. The control units 12 also include alarms, such as a noisemaker and/or a light, to indicate that the water heater has been shut off due to a leak. The shut-off systems 10a, 10b thereby prevent additional water, power, and natural gas from reaching the water heaters until the heater is fixed and the shut-off systems 10a, 10b reset. Because of the waterproof construction of the detector pads 100, the pads can be dried and reused once the floor is also dried.

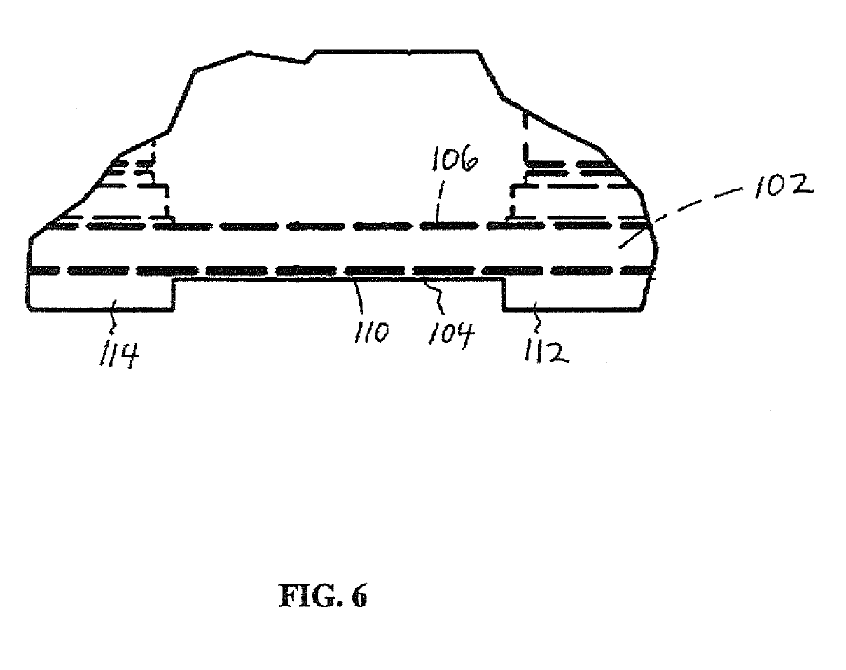

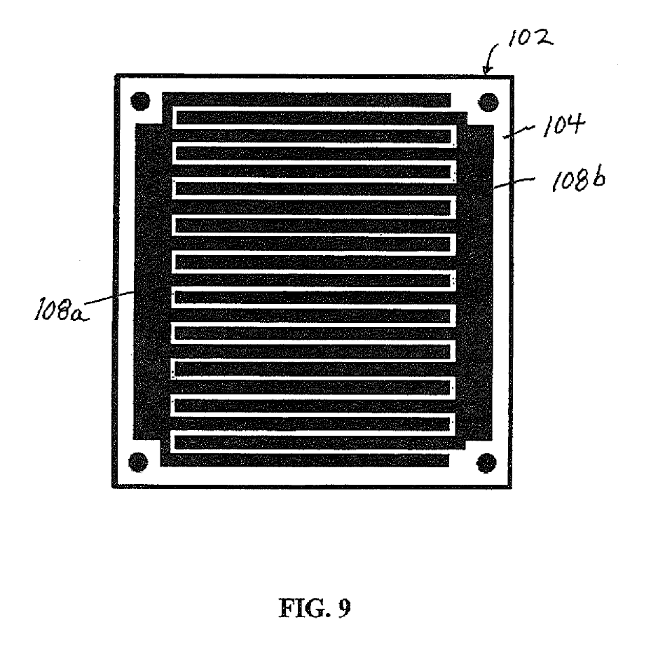

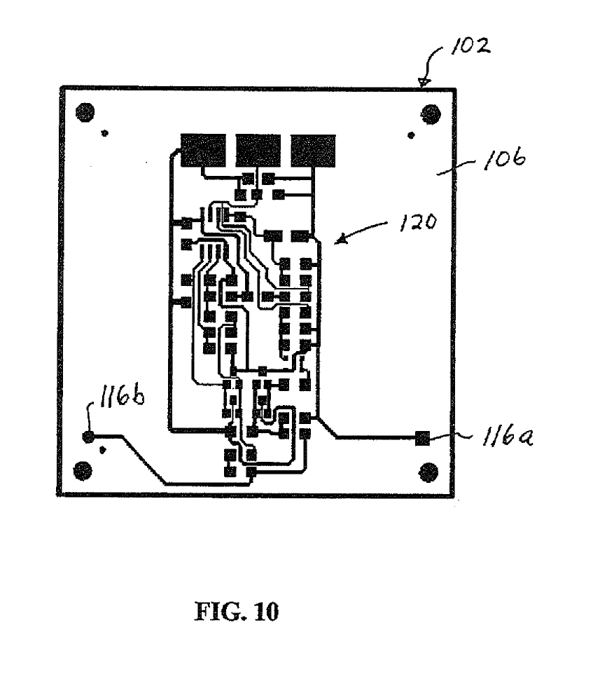

Referring now to FIGS. 2-13, the leak detector pad 100 includes a circuit board 102 having a bottom surface 104 and a top surface 106, spaced first and second electrically conductive traces 108a, 108b located on the bottom surface of the circuit board 104, as shown best in FIG. 9, and an electronic circuit 120 mounted on the top surface 106 of the circuit board 102, as shown best in FIG. 10. A watertight encapsulation layer 110 covers the bottom surface 104 of the circuit board 102 and the traces 108a, 108b and the top surface 106 of the circuit board and the electronic circuit 120. The encapsulation layer 110 can be seen, for example, in the enlarged view of the pad 100 shown in FIG. 6. According to one exemplary embodiment, the waterproof encapsulation layer 100 comprises a thermoplastic polyimide, such as the MACROMELT® OM line of low pressure molding materials available from Henkel in Düsseldorf, Germany.

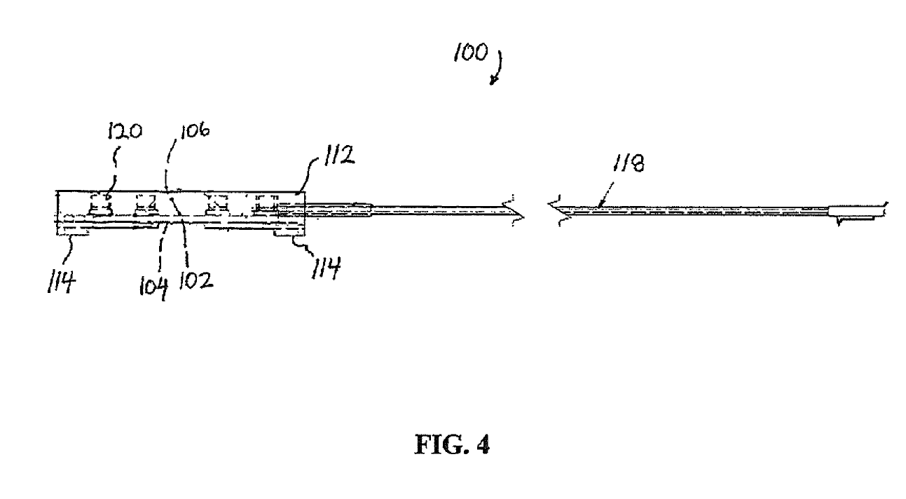

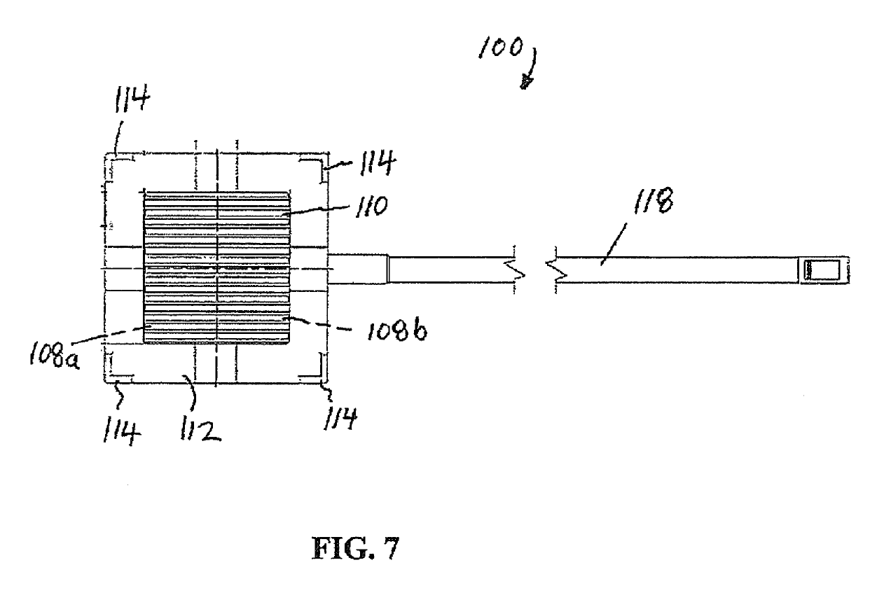

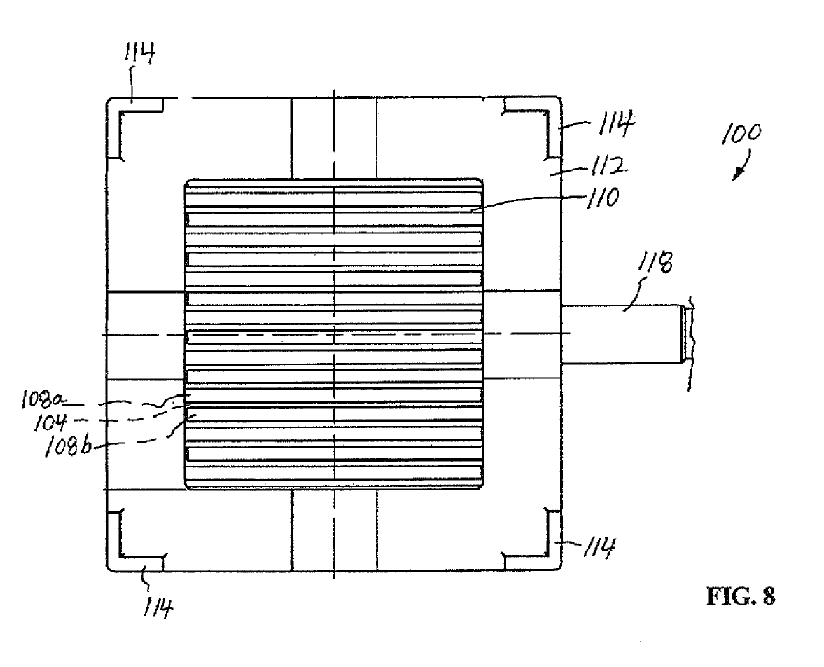

The leak detector pad 100 also includes a relatively thicker, shock-absorbing, watertight over-mold layer 112 covering the encapsulation layer 110 on the top surface 106 of the circuit board 102 and the electronic circuit 120, side edges of the circuit board 102, and the encapsulation layer 110 on edge portions of the bottom surface 104 of the circuit board. As shown best in FIGS. 7 and 8, the over-mold layer 112 does not extend over fingers of the traces 108a, 108b. The over-mold layer 112 includes legs 114 extending from the edge portions of the bottom surface 104 of the circuit board 120, as shown best in FIGS. 4-8. According to one exemplary embodiment, the over-mold layer 112 also comprises a thermoplastic polyamide, such as the MACROMELT® OM line of low pressure molding materials.

Referring to FIG. 9, the traces 108a, 108b comprise co-planer inter-digitated fingers 109. The traces 108a, 108b are made of an electrically conductive material, such as copper, and are connected to the electronic circuit 120 through holes 116a, 116b in the circuit board 102. The holes 116a, 116b can be seen, for example, in FIG. 10.

In one embodiment, the inter-digitated array of fingers 109 is inter-digitated sets of traces 108a, 108b on one side of a printed circuit board. Holes 111a-d may be used for the attachment of feet or other mounting hardware.

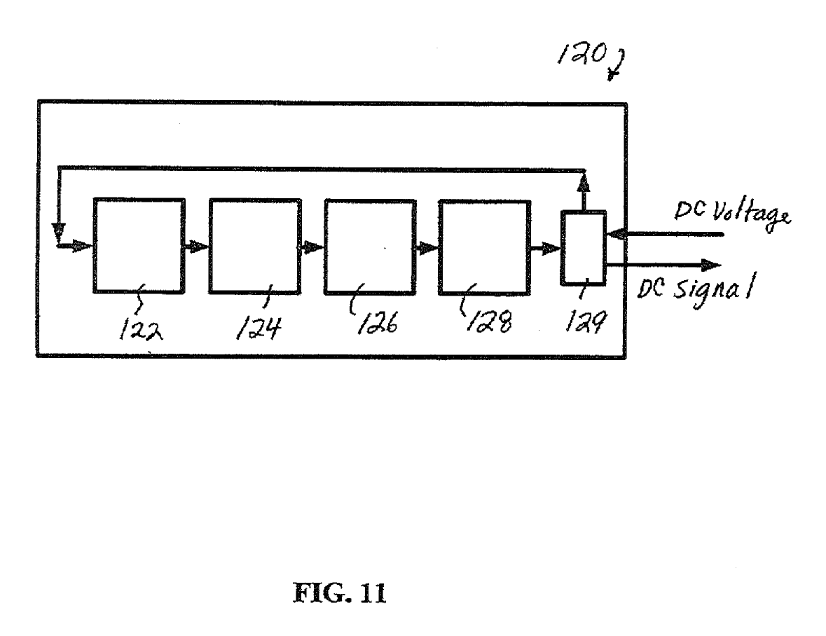

Referring to FIGS. 11-13, the electronic circuit 120 includes a first segment 122 adapted to create an AC voltage waveform from the DC voltage provided by the control unit 12, a second segment 124 adapted to apply the AC voltage waveform between the traces 108a, 108b on the bottom surface 104 of the circuit board 102, a third segment 126 adapted to create a DC voltage indicative of a measure of a capacitance between the traces 108a, 108b based upon an AC current flowing between the traces 108a, 108b as a result of the AC voltage waveform, and a fourth segment 128 adapted to create a DC voltage alarm signal if the measure of capacitance provided by the third segment 126 indicates the presence of fluid.

The electronic circuit 120 further includes a fifth segment 129 connected to a cable 118 for connection to the control unit 12. The fifth segment 129 is adapted to provide electrical power to the other segments of the circuit 120 and receive the DC voltage alarm signal from the fourth segment 128. The watertight over-mold layer 112 extends over a portion of the cable 118 to provide strain relief.

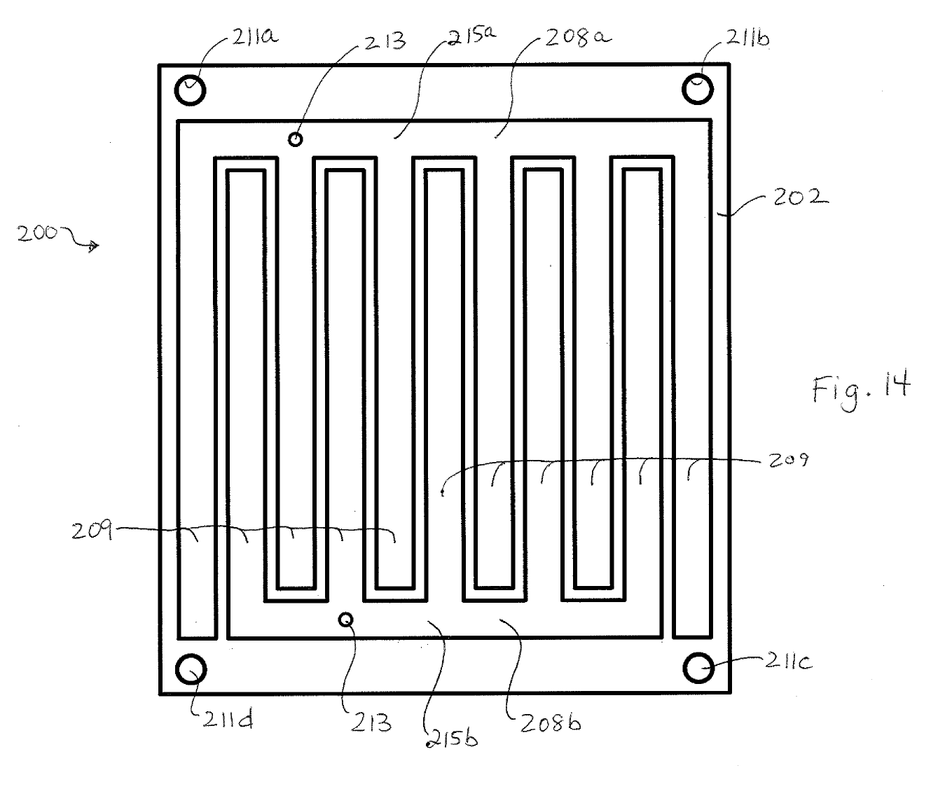

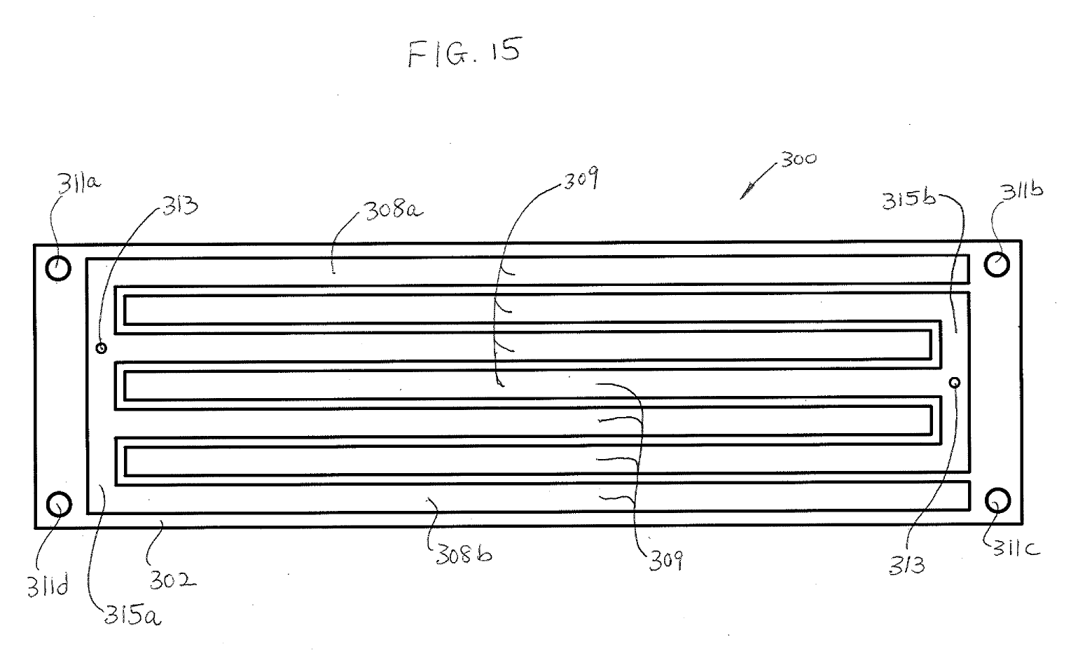

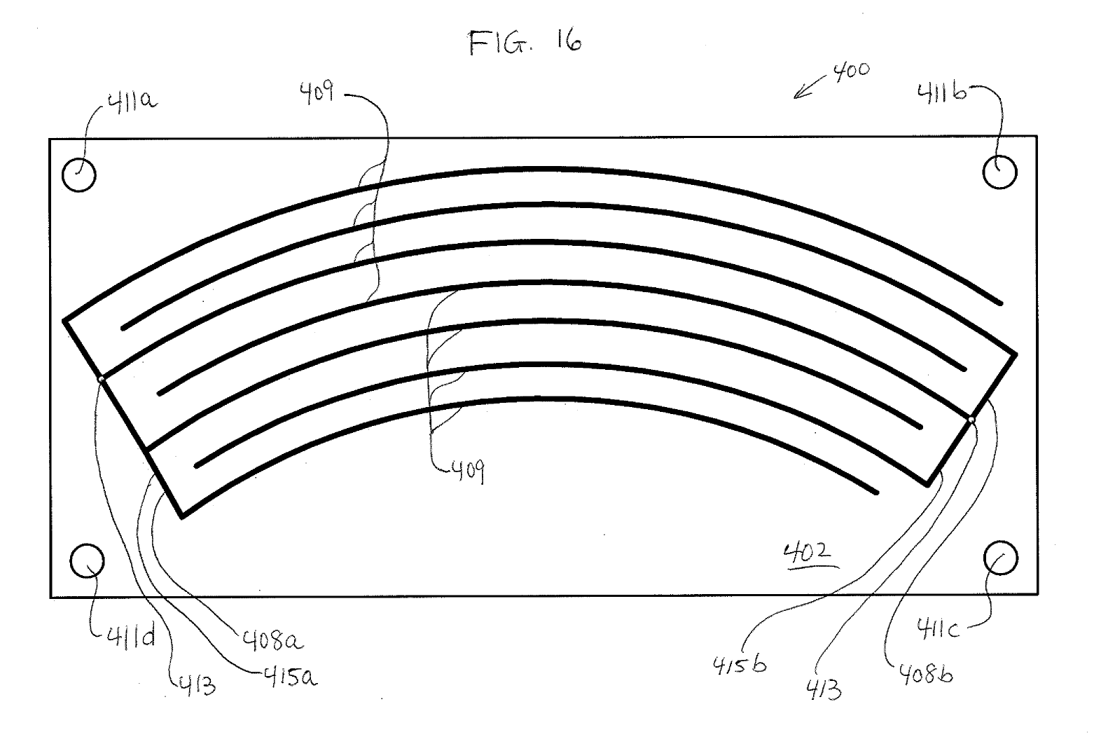

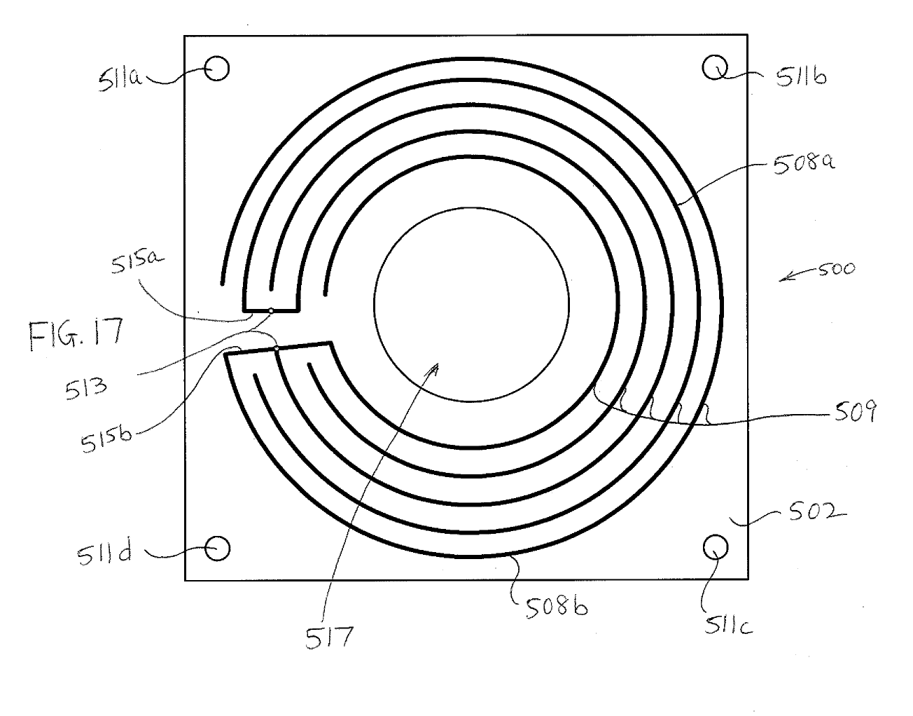

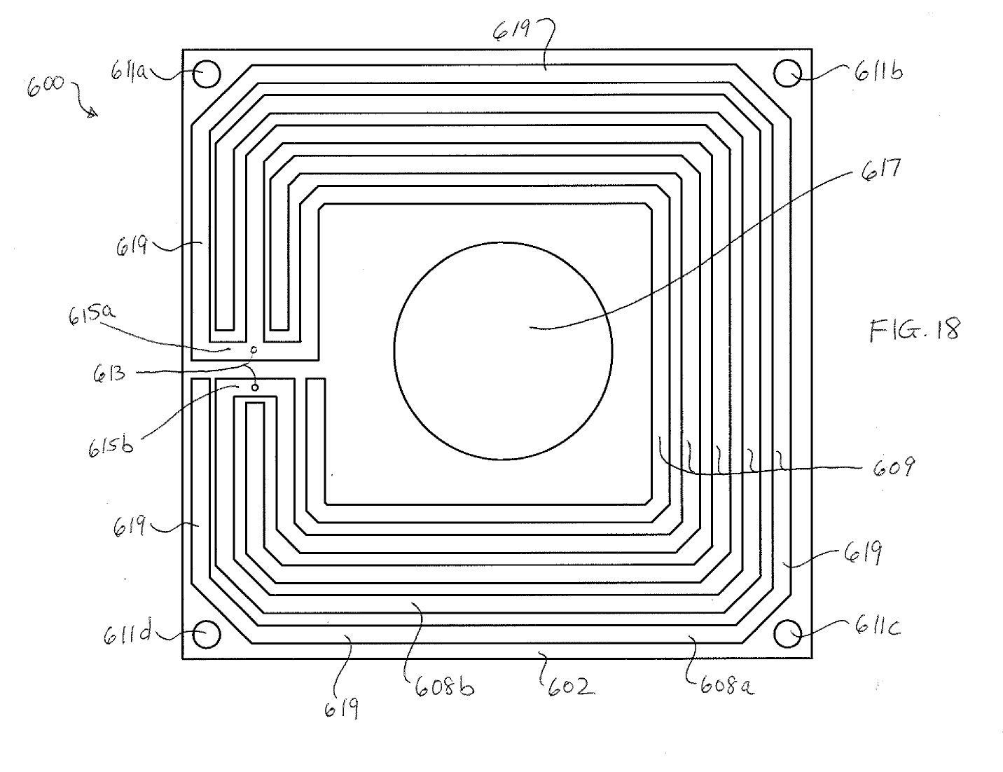

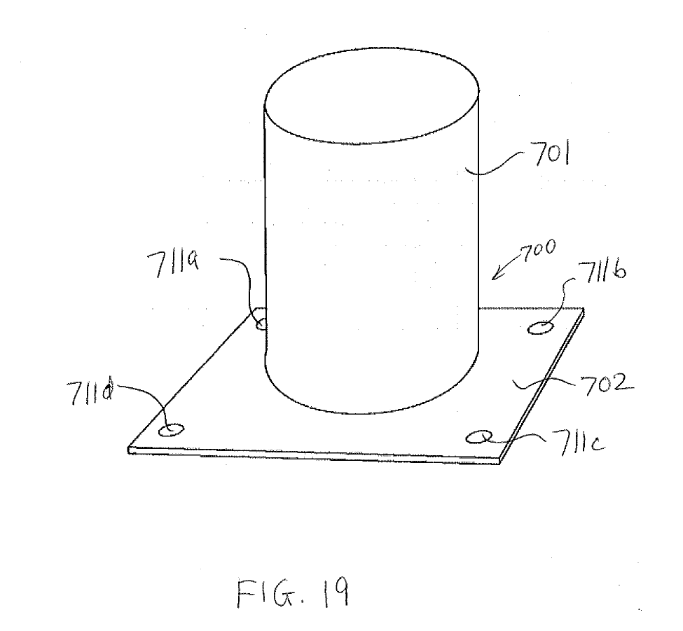

Turning to FIG. 14, a plan view of a bottom surface of a circuit board 202 of another leak detector pad 200 having exemplary embodiments of two sets of traces 208a, 208b according to the present disclosure is shown. As will be appreciated by those of ordinary skill in the pertinent art, the leak detector pad 200 utilizes similar principles to the leak detector pad 100 described above. Accordingly, like reference numerals preceded by the numeral “2” instead of the numeral “1”, are used to indicate like elements. The primary difference of the leak detector pad 200 in comparison to the leak detector pad 100 is the different shape of the sets of traces 208a, 208b. Any number of fingers may be employed in the inter-digitated array of fingers 209.

The traces 208a, 208b show an alternative array of inter-digitated fingers 209 for use with the water-detecting circuitry, in which fewer fingers 209 are employed relative to the array of FIG. 9. Shown on the two inter-digitated traces 208a, 208b are holes or vias 213 for the connection of circuitry on the opposing side of the printed circuit board 205, or for the insertion of interconnecting wires. Holes 213 may be used for the attachment of feet or other mounting hardware.

The arrays of inter-digitated fingers 109, 209 shown in FIGS. 9 and 14 are approximately square in shape but any shape is possible. Turning to FIG. 15, a plan view of a bottom surface of another circuit board 302 of another leak detector pad 300 having exemplary embodiments of two sets of traces 308a, 308b according to the present disclosure is shown. As will be appreciated by those of ordinary skill in the pertinent art, the leak detector pad 300 utilizes similar principles to the leak detector pads 100, 200 described above. Accordingly, like reference numerals preceded by the numeral “3” instead of the numerals “1” or “2”, are used to indicate like elements.

FIG. 15 shows an alternative array of inter-digitated fingers 309 for use with the water-detecting circuitry, in which the traces 308a, 308b have been elongated. End portions or connectors 315a, 315b have holes 313 for the connection of circuitry on the opposing side of the printed circuit board 302, or for the insertion of interconnecting wires. Holes 311a-d may be used for the attachment of feet or other mounting hardware.

Turning to FIGS. 16-18, plan views of a bottom surface of circuit board 402, 502, 602 of detector pads 400, 500, 600, respectively, having exemplary embodiments of two sets of traces 408a, 408b, 508a, 508b, 608a, 608b according to the present disclosure are shown. As will be appreciated by those of ordinary skill in the pertinent art, the leak detector pads 400, 500, 600 utilize similar principles to the leak detector pads 100, 200, 300 described above. Accordingly, like reference numerals preceded by the numerals “4”, “5” or “6” instead of the numerals “1”, “2” or “3”, are used to indicate like elements. FIGS. 16 and 17 are drawn somewhat schematically for clarity. It is envisioned that the fingers 409, 509 would preferably be as wide as possible with as narrow as possible separations for best performance.

FIG. 16 shows an alternative array of inter-digitated fingers 409 for use with the water-detecting circuitry, in which the sets of traces 408a, 408b are arcuate. The variation of the shape of the inter-digitated array includes a curvature applied to yield a banana-shaped array. End-connectors 415a, 415b have holes 413 for the connection of circuitry on the opposing side of the printed circuit board 405, or for the insertion of interconnecting wires.

FIG. 17 shows a further variation of the shape of the inter-digitated array, in which the sets of traces 508a, 508b are circular tracks to yield a Rings-of-Saturn or circular race-track appearance. End connectors 515a, 515b also have holes 513 for the connection of circuitry on the opposing side of the printed circuit board 502 or for the insertion of interconnecting wires. End connectors 515a, 515b are conveniently located in close proximity to each other. A central hole 517 provides for the passage of water through the center of the printed circuit board 502. The electronic water-detection circuitry may be mounted on the upper side of printed circuit board 502.

FIG. 18 shows yet a further variation of the shape of the inter-digitated array, in which the circular race-track configuration has been given straight sides 619, thereby producing an array with a square or rectangular race-track appearance. End connectors 615a, 615b have holes 613 for the connection of circuitry on the opposing side of the printed circuit board 602, or for the insertion of interconnecting wires. End-connectors 601 and 602 are conveniently located in close proximity to each other.

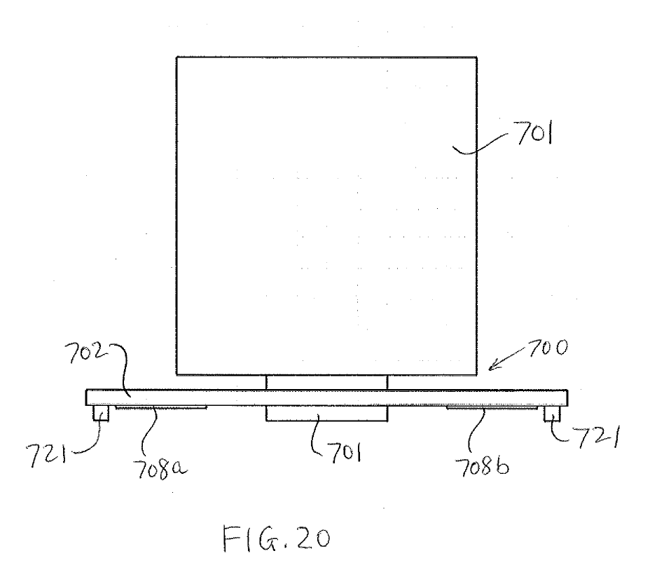

Referring now to FIGS. 19 and 20, perspective and side views, respectively, of an integrated arrangement wherein a water pump 701 is mounted on top of a printed circuit board 702 having inter-digitated tracks 708a, 708b. The printed circuit board 702 may be any arrangement as shown herein as well as other arrangements in accordance with the subject technology. The printed circuit board 701 may also have holes for the attachment of feet or other mounting hardware. Printed circuit board 702 includes the necessary means for detecting the presence of water, and an electrical or electronic switch is used to turn water pump 701 on or off in response to the detection of water by way of printed circuit board 702. Water pump 701 may be of any of the types capable of ingesting water from beneath, including positive-displacement pumps, piston pumps, diaphragm pumps, centrifugal pumps, axial-flow pumps and the like.

Water pump 701 is mounted on top of and protruding through printed circuit board 702. The printed circuit board 702 has inter-digitated tracks 708a, 708b on an underside. The close proximity of a metallic water pump body to the inter-digitated tracks 708a, 708b will not significantly affect operation of the water detection system, especially when using circuitry as noted above. Likewise, close proximity of a metallic support frame to the inter-digitated tracks 708a, 708b will not significantly affect operation of the water detection system 700. Attachment feet 721 are mounted in holes 711a-d for providing desired separation of the underside of the pump 701, and of the underside of printed circuit board 702, from the bilge or basement floor whereon the assembly is employed. Electronic circuitry may be mounted on the upper side of printed circuit board 802, as noted above.

The present disclosure, therefore, provides a new and improved leak detector pad. It should be understood, however, that the exemplary embodiment described in this specification has been presented by way of illustration rather than limitation, and various modifications, combinations and substitutions may be effected by those skilled in the art without departure either in spirit or scope from this disclosure in its broader aspects and as set forth in the appended claims. Accordingly, other embodiments are within the scope of the following claims. In addition, the leak detector pad disclosed herein, and all elements thereof, are contained within the scope of at least one of the following claims. No elements of the presently disclosed leak detector pad are meant to be disclaimed.

What is claimed is:

1. A leak detector pad comprising:
a circuit board having a bottom surface and a top surface;
spaced first and second electrically conductive traces located on the bottom surface of the circuit board;
an electronic circuit mounted on the top surface of the circuit board and including,
a first segment adapted to apply an AC voltage waveform between the traces on the bottom surface of the circuit board,
a second segment adapted to create a measure of a capacitance between the traces based upon an AC current flowing between the traces as a result of the AC voltage waveform, and
a third segment adapted to create an alarm signal if the measure of capacitance provided by the second segment indicates a presence of fluid.

2. A leak detector pad according to claim 1, further comprising a watertight encapsulation layer covering the bottom surface of the circuit board and the traces.

3. A leak detector pad according to claim 1, wherein the traces comprise inter-digitated fingers.

4. A leak detector pad according to claim 6, wherein the traces are co-planar.

5. A leak detector pad according to claim 1, wherein the traces are connected to the electronic circuit through holes in the circuit board.

6. A leak detector pad according to claim 1, wherein the second segment of the electronic circuit is adapted to create a DC voltage indicative of the measure of the capacitance between the traces.

7. A water detector shut-off system including the leak detector pad of claim 1 and further including:
a valve far controlling a water supply;
a controller adapted to close the valve upon receiving the alarm signal from the leak detector pad;
an alarm, wherein the controller is adapted to activate the alarm upon receiving the alarm signal from the leak detector pad and activate power cutout modules to shut off power;
a dam surrounding the detector pad;
a reset button associated with the controller adapter; and
a noisemaker/warning light associated with the alarm.

8. A leak detector comprising:
a circuit board having a bottom surface and a top surface, and holes connecting the bottom and top surfaces;
spaced first and second electrically conductive traces located on the bottom surface of the circuit board; and
an electronic circuit mounted on the top surface of the circuit board and connected to the traces through the holes in the board, the circuit including, a sensing portion for creating a measure of a capacitance between the traces based upon a current flowing between the traces and a signal generating portion for creating a voltage alarm signal if a measure of the capacitance indicates presence of fluid about the bottom surface.

9. A leak detector as recited in claim 8, wherein the traces define at least one via for connection of circuitry on the top surface.

10. A leak detector as recited in claim 8, wherein the traces have a shape selected from square, arcuate, circular, polygonal and combinations thereof.

11. A leak detector as recited in claim 8, wherein the traces have elongated fingers.

12. A leak detector as recited in claim 8, wherein the traces have end connectors located in close proximity to each other.

13. A leak detector as recited in claim 8, wherein the circuit board defines a central hole.

14. A leak detector as recited in claim 8, further comprising a watertight encapsulation layer covering the bottom surface of the circuit board and the traces.

15. A leak detector for use with a water pump comprising:
a circuit board having a surface;
spaced first and second electrically conductive traces located on the surface of the circuit board; and
an electronic circuit mounted on the circuit board and connected to the traces, the electronic circuit adapted to measure a capacitance between the traces, and create a voltage alarm signal if the capacitance indicates fluid.

16. A leak detector as recited in claim 15, wherein the water pump is mounted on the circuit board.

17. A leak detector as recited in claim 15, wherein the circuit board has holes and further comprising feet mounted in the holes.

18. A leak detector as recited in claim 15, further comprising a switch used to turn on the water pump based upon the voltage alarm.

19. A leak detector as recited in claim 15, wherein the water pump ingests water from beneath and is selected from the group consisting of a positive-displacement pump, a piston pump, a diaphragm pump, a centrifugal pump, an axial-flow pump and combinations thereof.

20. A leak detector as recited in claim 15, wherein the water pump is mounted on a top of the circuit board and protrudes through the circuit board, the traces are on an underside of the circuit board, and the electronic circuit is mounted on an upper side of the circuit board.
